(19) United States
(12) Patent Application Publication
(10) Pub. No.: US 2016/0347395 A1
(43) Pub. Date: Dec. 1, 2016

(54) ANIMAL DECORATION KIT FOR BICYCLE, TRICYCLE, SCOOTER OR THE LIKE

(71) Applicant: Stephanie Nelson-Pondrom, St. Louis, MO (US)

(72) Inventor: Stephanie Nelson-Pondrom, St. Louis, MO (US)

(21) Appl. No.: 15/168,435

(22) Filed: May 31, 2016

Related U.S. Application Data
(60) Provisional application No. 62/168,961, filed on Jun. 1, 2015.

(51) Int. Cl. B62J 99/00

(52) U.S. Cl. CPC B62J 99/00; B62J 2099/0086

(57) ABSTRACT

An animal decoration kit for a bicycle or tricycle is provided. The decoration kit is configured to mount to the exterior of a bicycle or tricycle. The decoration kit includes each of a handlebar attachment member and a seat attachment member to transform the bicycle into an animal such as a horse or other creature. The decoration kit provides a recess for storing items, and safety reflective tape to make the decorative kit useful and practical for children. The handlebar attachment member may also include a handle so that when the handlebar attachment member is removed, it may serve as a bag or tote for carrying belongings.

### CROSS-REFERENCE TO RELATED APPLICATIONS

This application claims the benefit of U.S. Provisional Application No. 62/168,961, filed Jun. 1, 2015, which is hereby incorporated by reference in its entirety.

### BACKGROUND OF THE INVENTION

Children often imagine their bicycles, tricycles, or scooters as majestic horses or other creatures. Such imagination play allows kids to feel safer and be more confident when riding their bicycles, tricycles, or scooters. It further allows for creative development. There are several devices currently available on the market to transform bicycles or tricycles to appear as animals or other creatures. However, the existing devices have a number of drawbacks.

Existing devices for “transforming” bicycles into animals and other creatures often require structural modifications to the bicycle or tricycle itself. Such modifications can materially affect the bicycle's performance. Other devices are made of a hard, heavy material and therefore weigh down a bicycle or tricycle, thus affecting its performance. Yet other embodiments are specifically designed to fit a single bicycle or tricycle, or require tools besides the apparatus itself for installation.

Thus there is a need to provide a fun, safe, and useful kit that is able to “transform” a bicycle or tricycle into a fun animal or other creature.

### SUMMARY OF THE PRESENT INVENTION

An animal decoration kit for attachment to a bicycle is provided. The animal decoration kit may “transform” an ordinary bicycle or tricycle into an animal or other creature. Such a “transformation” allows a child riding the bicycle or tricycle to imagine that he or she is riding an animal or other creature instead of a simple mechanical bicycle or tricycle. The kit should be able to work with existing bicycle and tricycles, and the kit should be easily transferrable from one device to another with no need for additional tooling.

The decoration kit includes a handlebar attachment member that includes a recess forming a pocket for storing various items therein. The handlebar attachment member also includes upper attachment straps at its upper portion and ties at its lower portion. The upper attachment straps and the ties are for selectively attaching the handlebar attachment member to a handlebar of a bicycle.

The decoration kit also includes a seat attachment member that includes an inner strap and an outer strap, wherein the inner strap and the outer strap are for selective attachment to a seat of the bicycle.

In at least one embodiment, the handlebar attachment member includes a handle for toting the handlebar attachment member when the handlebar attachment member is removed from the bicycle.

In another separate embodiment, the handlebar attachment member includes reflective safety material, such as tape. The reflective safety tape may be in a number of decorative shapes, for example, an eye or a horse bridle

In yet another embodiment, the handlebar attachment member is in the shape of an animal head, for example a horse head.

### BRIEF DESCRIPTION OF THE DRAWINGS

In the accompanying drawings, which form a part of the specification and are to be read in conjunction therewith in which like reference numerals are used to indicate like or similar parts in the various views:

FIG. 1 is an elevation view of an animal decoration kit attached to a bicycle subject to the teachings of the present invention;

FIG. 2 is a perspective view of a handlebar attachment member of the animal decoration kit of FIG. 1;

FIG. 3 is a perspective view of the handlebar attachment member of FIG. 1 shown attached to a handlebar;

FIG. 4 is a side elevation view of the handlebar attachment member of FIGS. 2 and 3;

FIG. 5 is a plan view of a seat attachment member of the animal decoration kit of FIG. 1; and

FIG. 6 is a perspective view of the seat attachment member of FIG. 5 attached to a seat.

### DETAILED DESCRIPTION OF THE INVENTION

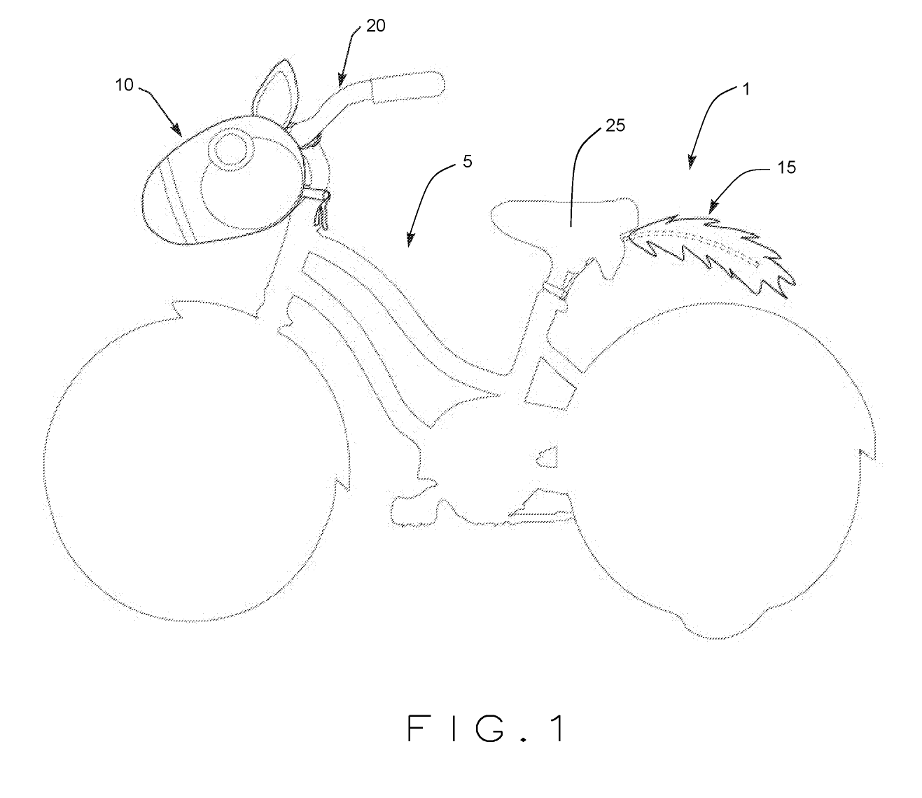

The present invention provides a decoration kit for selective attachment to a bicycle or tricycle. FIG. 1 illustrates decoration kit 1 attached to a bicycle 5, though in alternative embodiments, decoration kit 1 may be attached to a tricycle. As shown and illustrated in FIG. 1, decoration kit 1 preferably comprises a handlebar attachment member 10 and a seat attachment member 15. Handlebar attachment member 10 is preferably in the shape of an animal head such as a horse, and seat attachment member 15 is preferably in the shape of an animal tail such as a horse, though in alternative embodiments, attachment members 10, 15 may take the form of other decorative structures. In at least one embodiment, attachment member 10 may take on the form of a mythical animal like a unicorn or a dragon.

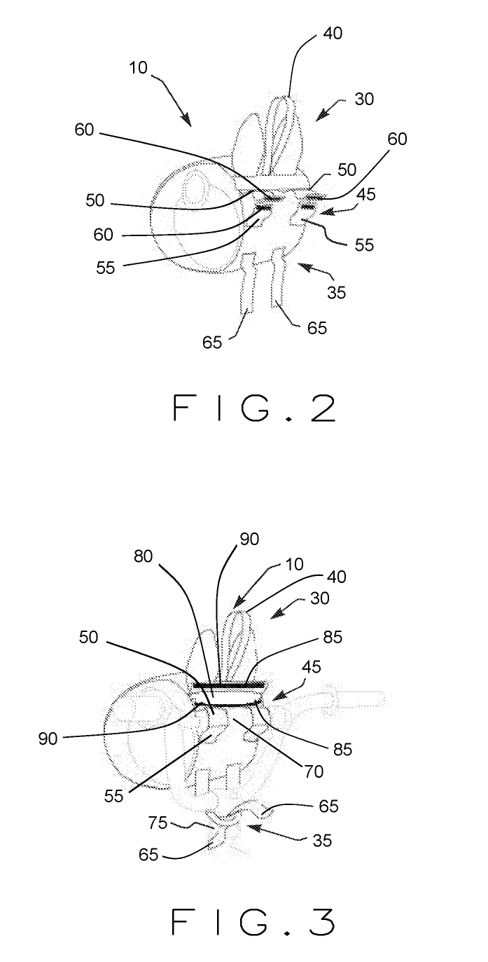

Handlebar attachment member 10 is preferably attachable to handlebar 20 of bicycle 5 (or in the alternative a handlebar of a tricycle), and seat attachment member 15 is preferably attachable to seat 25 of bicycle 5 (or in the alternative a seat of a tricycle). The method and mechanism by which handlebar attachment member 10 and seat attachment member 20 may be attached to bicycle 5 are described in greater detail in the descriptions of FIGS. 2-6 herein below.

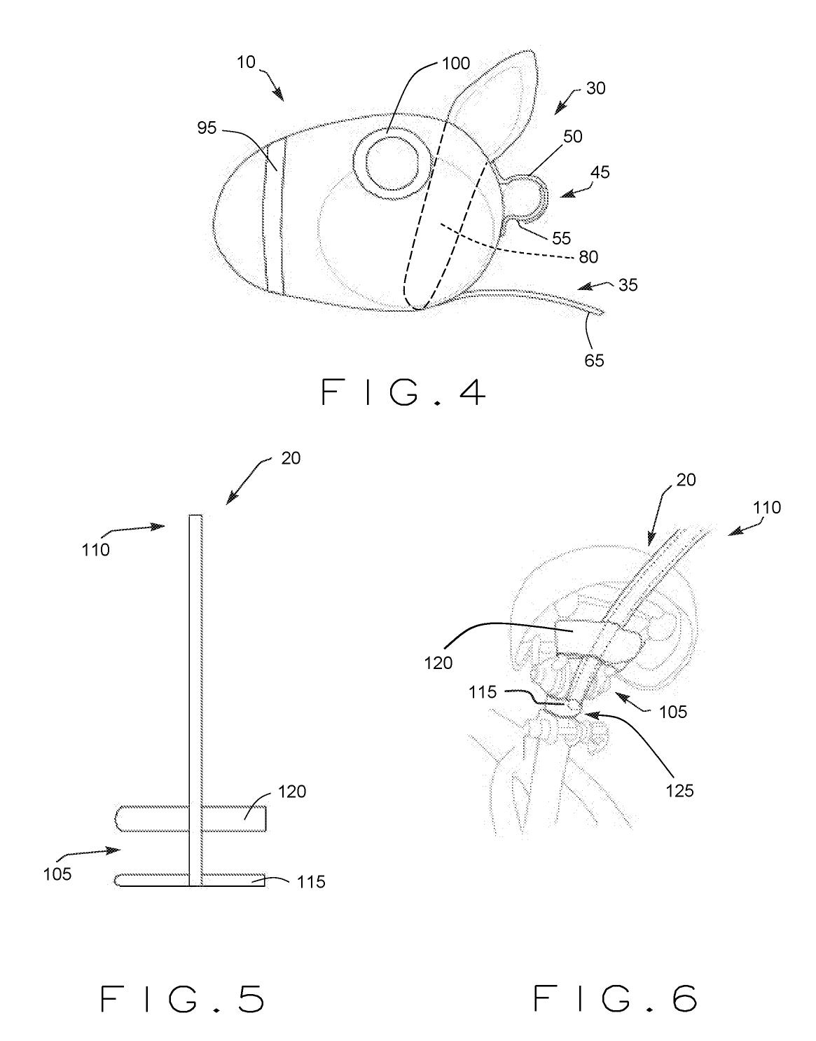

FIGS. 2-4 illustrate various perspective views of handlebar attachment member 10. FIG. 2 illustrates handlebar attachment member 10 in its unattached, freestanding position, FIG. 3 illustrates attachment member 10 attached to handlebar 20, and FIG. 4 illustrates attachment member 10 from a side elevation view, thus showing some of its features in greater detail.

Attachment member 10 includes an upper portion 30 and a lower portion 35. Upper portion 30 may include a handle member 40 that may be used to tote attachment member 10 when it is detached from bicycle 5, for example as shown in FIG. 2. When detached from bicycle 5, attachment member 10 may be used as a tote for carrying school books, personal goods, snacks, and other items. Upper portion 30 of attachment member 10 may further include a pair of attachment straps 45, each of which include an upper strap 50 and a lower strap 55. Upper strap 50 and lower strap 55 preferably include fastening members 60 for releasably attaching the upper strap 50 and lower strap 55 to one another. In the embodiment illustrated in FIG. 2, fastening members 60 are Hook and loop strips, but in alternative embodiments could be other known fastening members such as ties, buckles, or snaps, all of which are non-limiting examples. Attachment member 10 may also include ties 65 located at lower portion 35 of attachment member 10.

As shown in FIG. 3, upper strap 50 and lower strap 55 may be secured to one another around a crossbar 70 of handlebar 15, and ties 65 may be secured to one another around a base portion 75 of handlebar 15. In alternative embodiments having a different handlebar 15 assembly (for example a non-“BMX” style bicycle), straps 50, 55 may still be utilized to attach attachment member 10. When straps 50, 55 and ties 65 are secured to handlebar 15 in the above described configuration, attachment member 10 is preferably secured to bicycle 5 sufficiently to allow a rider to ride bicycle 5 with attachment member 10 safely and securely attached thereto.

FIG. 3 further illustrates a recess forming a pocket 80 associated with attachment member 10 for storing equipment, toys, and other items within attachment member 10. Recess 80 is shown in its open configuration in FIG. 3. Flaps 85 of recess 80 may be secured to one another by fastening members 90, which in the illustrated embodiment are hook and loop fasteners, though in alternative embodiments could be other foreseeable or known fastening members such as zippers or snap fasteners. Flaps 85 may be opened and closed as desired to access items within recess 80 or secure items within recess 80, respectively.

As shown in FIG. 4, attachment member 10 may further include a first strip of reflective safety tape 95 and a second strip of reflective safety tape 100 for providing a safety feature to the attachment member 10. Tape 95, 100 increases awareness of cars that the bicycle 5 and its rider are present when it is dark outside. In the embodiment illustrated in FIG. 4, reflective safety tape 95, 100 are in the form of a bridle and eye of a horse, respectively. In other embodiments, tape 95, 100 could serve as adornment for another animal or creature, including but not limited to a nose, hair, mane, etc. In alternative embodiments, more or less reflective safety tape may be provided.

FIG. 5 illustrates seat attachment member 15 having each of a proximal end 105 and a distal end 110 with no decorative adornment attached thereto. In a preferred embodiment, attachment member 15 may include decorative adornment attached to distal end 110, such as a tail-like design or other decorative feature (for example in FIG. 1). In at least one embodiment, different types of decorative adornments may be swapped out so that a child may imaginatively ride on the animal of his or her choice simply by switching the adornment (attachment member 10 may similarly be interchangeable). The adornment may be integrally formed with seat attachment member 15 in at least one embodiment.

At proximal end 105 of attachment member 20, each of an inner strap 115 and an outer strap 120 may be provided. Straps 115, 120 are each able to be secured to themselves by fastening members (not illustrated) for securement around an adjustment stem 125 of seat 25. The fastening members may be loops, hook and loop, buckles, or other known or foreseeable fastening members to those skilled in the art. Strap 115 may be thinner than strap 120 as shown in FIG. 5 to provide space between seat 25 and stem 125. FIG. 6 illustrates straps 115, 120 secured to stem 125, thus securing attachment member 20 to bicycle 5.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel animal decoration kit for a bicycle or tricycle. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An animal decoration kit for attachment to a bicycle, the animal decoration kit comprising:
a handlebar attachment member comprising a recess and further including each of upper attachment straps and ties, wherein the upper attachment straps and the ties are for selective attachment of the handlebar attachment member to a handlebar of a bicycle; and
a seat attachment member including an inner strap and an outer strap, wherein the inner strap and the outer strap are for selective attachment to a seat of the bicycle.

2. The animal decoration kit of claim 1, wherein the handlebar attachment member includes a handle for toting the handlebar attachment member when the handlebar attachment member is removed from the bicycle.

3. The animal decoration kit of claim 1, wherein the handlebar attachment member includes reflective safety tape.

4. The animal decoration kit of claim 1, wherein the handlebar attachment member is in the shape of an animal head.

5. The animal decoration kit of claim 3, wherein the reflective safety tape is in the shape of at least one of an eye and a horse bridle.
